(19) United States
(12) Patent Application Publication
(10) Pub. No.: US 2019/0327932 A1
(43) Pub. Date: Oct. 31, 2019

(54) Protective Sling for Vehicle

(71) Applicant: John B. Adrain, Spokane, WA (US)

(72) Inventor: John B. Adrain, Spokane, WA (US)

(21) Appl. No.: 16/396,602

(22) Filed: Apr. 26, 2019

Related U.S. Application Data
(60) Provisional application No. 62/663,672, filed on Apr. 27, 2018.

(51) Int. Cl. A01K 1/02; B60R 7/04; B60P 3/04

(52) U.S. Cl. CPC A01K 1/0272; B60P 3/04; B60R 7/043

(57) ABSTRACT

A bed device having sidewalls and a bottom that forms an interior region for holding materials such as pets such as dogs for installation in a vehicle by mounting headrest mounts over the headrests of a vehicle.

This application claims the benefit of U.S. Provisional Patent Application Ser. No. 62/663,672 filed on Apr. 27, 2019, incorporated herein by reference in its entirety.

### BACKGROUND

Dogs and other animals are often transported in vehicles. However, animals cannot be secured by seat belt, and hence such travel can be risky to the life and health of the unsecured animal in certain situations, such as during fast stops or accidents. Also, animals can damage the interior of the vehicle due to their playful nature and sharp claws and teeth. Furthermore, various articles can be difficult to carry securely in a vehicle.

### SUMMARY

Provided are a plurality of example embodiments, including, but not limited to, a sling device that can be installed in a vehicle to protect an animal from harm while also protecting the interior of the vehicle as well.

Also provided is a bed device for installation in a vehicle comprising: a bed having a first sidewall, a second sidewall, and a bottom provided between said first sidewall and said second sidewall; a front headrest cup attached to an edge of the first sidewall of the bed; and a back headrest cup attached to the edge of the second sidewall of the bed.

The bed device is configured such that said front headrest cup is adapted to cup a first row headrest in the vehicle, and said back headrest cup is adapted to cup a second row headrest in the vehicle, and when said bed is installed in the vehicle, the first sidewall forms a wall along the first row, said second sidewall forms a wall along said second row, and said bottom forms a base between said first sidewall and said second sidewall for holding material in said device.

Further provided is a bed device for installation in a vehicle comprising: a bed having a first sidewall, a second sidewall, and a bottom provided between said first sidewall and said second sidewall; a first headrest cup attached to an edge of the first sidewall of the bed toward a first end of the first sidewall; a second headrest cup attached to the edge of the first sidewall of the bed toward a second end of the first sidewall; a third headrest cup attached to an edge of the second sidewall of the bed toward a first end of the second sidewall; and a fourth head rest cup attached to an edge of the second sidewall of the bed toward a second end of the second sidewall.

The bed device is configured such that said first headrest cup is adapted to cup a first first row headrest in the vehicle, said second headrest cup is adapted to cup a second first row headrest in the vehicle, said third headrest cup is adapted to cup a first second row headrest in the vehicle, and the fourth headrest cup is adapted to cup a second second row headrest in the vehicle, and when said bed is installed in the vehicle, the first sidewall forms a wall along the first row, said second sidewall forms a wall along said second row, and said bottom forms a base between said first sidewall and said second sidewall for holding material in said device.

Also provided is a bed device for installation in a vehicle comprising: a bed having a first sidewall, a second sidewall, and a bottom provided between said first sidewall and said second sidewall; a first headrest cup attached to an edge of the first sidewall of the bed toward a first end of the first sidewall; a second headrest cup attached to the edge of the first sidewall of the bed toward a second end of the first sidewall; a third headrest cup attached to an edge of the second sidewall of the bed toward a first end of the second sidewall; a fourth head rest cup attached to an edge of the second sidewall of the bed toward a second end of the second sidewall; a utility pocket provided at a juncture between one of the sidewalls and the bottom; and at least one zipper provided along a width of at least one of the sidewalls configured to provide access to an interior of the bed.

The bed device is configured such that said first headrest cup is adapted to cup a first first row headrest in the vehicle, said second headrest cup is adapted to cup a second first row headrest in the vehicle, said third headrest cup is adapted to cup a first second row headrest in the vehicle, and the fourth headrest cup is adapted to cup a second second row headrest in the vehicle, and when said bed is installed in the vehicle, the first sidewall forms a wall along the first row, said second sidewall forms a wall along said second row, and said bottom forms a base between said first sidewall and said second sidewall for holding material in said device.

Still further provided is a method of installing any of the above bed devices by connecting the headrest mounts to respective headrests in adjacent rows of the vehicle by slipping the headrest mounts over the respective headrests. The material held in the device(s) can be a pet such as a dog.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 is a schematic of a cut away of a side view of an example embodiment of a sling bed in a deployed position;

FIG. 2 is a schematic of a back view of the example embodiment of the sling bed in a deployed position;

FIG. 3 is a schematic of a front view of the example embodiment of the sling bed in a deployed position;

FIG. 4 is a schematic of a outer view of the example embodiment of the sling bed in a laid flat position;

FIG. 5 is a schematic view of an example removable and adjustable headrest mount; and

FIG. 6 is a perspective view of another example embodiment of a sling bed in a deployed position.

### DETAILED DESCRIPTION OF THE EXAMPLE EMBODIMENTS

Provided is a sling bed device that can be installed in an automobile, truck, SUV, van, or other vehicle prior to, or after, the initial sale. Such a device might be installed as a dealer provided and installed accessory, or sold for installation by a vehicle owner. A preferred embodiment would utilize existing vehicle structures, such as headrests for occupants, to easily and effectively secure the device in place. The sling bed can act like trampoline to break the force of an animal's trajectory forward in an accident. The bed can be generalized and made adjustable, or can ve custom made for each vehicle to utilize all of the safety fasten points including head rests and all car seat tie down locations including the ones on the rear window deck.

As shown in the accompanying figures, an example embodiment of the device is basically configured as a “sling” or hammock that is adapted for connection to the headrests of the both the front seats and rear seats of the vehicle. The headrests provide a secure connection point for headrest mounts of the device, which includes a material that extends from both the front and back headrests, providing a “bed” of sorts for the animal (e.g., dog) to reside in the vehicle during travel.

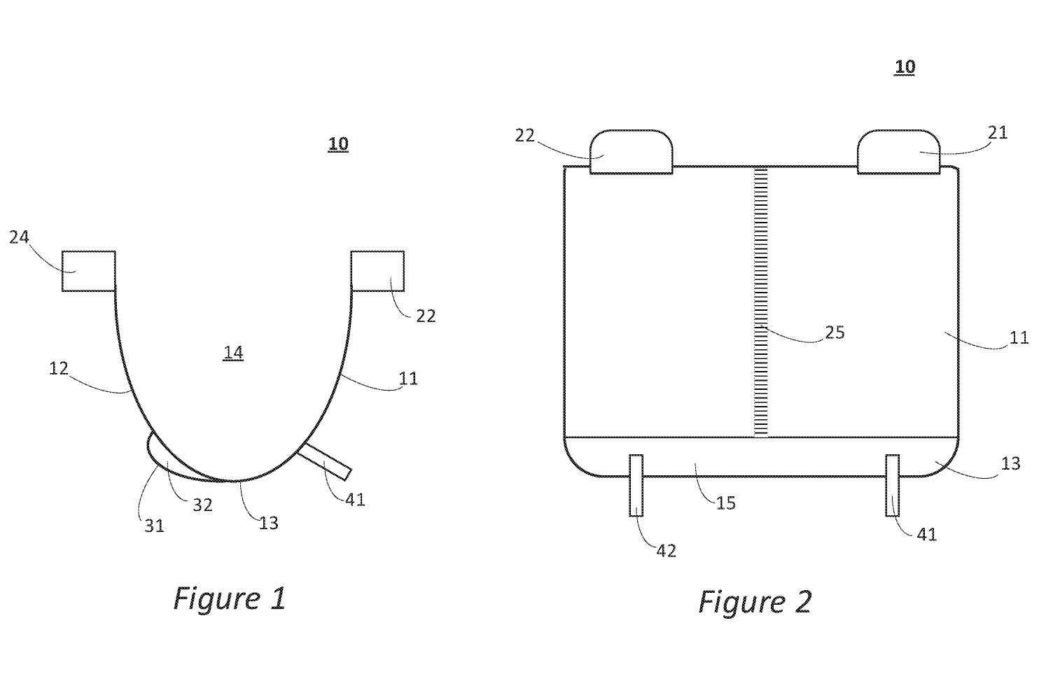

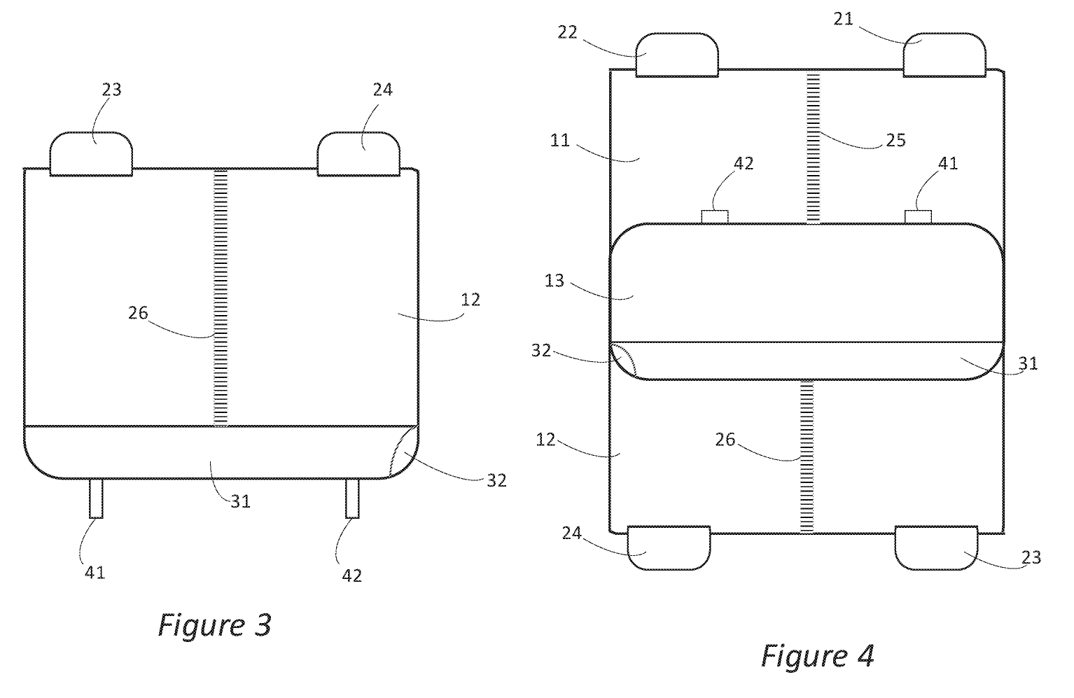

FIG. 1 is a schematic drawing of a side view of a first example embodiment 10 of a sling bed device in a deployed position, with FIG. 2 showing a back side view and FIG. 3 showing a front side view of the deployed device, whereas FIG. 4 shows a top (inner) view of the device laid out flat. The bed includes a first (back) sidewall 11, a second (front) sidewall 12, and a bottom 13 connecting the first sidewall 11 to the second sidewall 12. The sidewalls 11, 12 and bottom 13 may be comprised of a single portion of material, or the sidewalls 11, 12, may be separate pieces attached to the bottom 13 that may be of a more solid construction to provide a flat and strong surface. The sidewalls 11, 12 may be connected to the bottom 13 by stitching or glue or rivets or other connecting approaches, and strengthening materials may be provided at that connection point to shape and/or otherwise strengthen the connection.

The sidewalls 11, 12 and bottom 13 could be, for example, comprised of a single portion of canvass material with the edges overlapped or stitched or otherwise strengthened. Alternatively, three portions of material can be utilized for each of the sidewalls 11, 12 and bottom 13. Alternatively, this portion of the device might be comprised of other cloth, or plastic material, whether flexible or somewhat rigid in design.

As further shown in FIGS. 1-4, the device includes a first front headrest mount 21 and a second front headrest mount 22 connected to an edge of the first sidewall 11 that will be provided facing the back of the vehicle for connecting to headrests in the back seat of the vehicle, whereas a first front headrest mount 23 and a second front headrest mount 24 will be connected to an edge of the front sidewall 12 for connecting to headrests on the front seats of the vehicle (note that if the device is used in third or subsequent rows, headrests found along those rows will be the ones utilized). The headrest mounts 21, 22, 23, and 24 can be connected to the edge portions using stitching, glue, rivets, or other mounting techniques, and will overhang from the edge outwardly toward the front/back of the vehicle.

The headrest mounts 21, 22, 23, and 24 will form a hollow “cup” design having an opening at a bottom portion to receive the respective headrests with a open or closed top portion. These headrest mounts are designed to cover the headrest in a “cupping” fashion in a snug and secure manner in order to provide a secure connection point. These headrest mounts may be made in an adjustable manner so that they can adapt to different vehicle seat designs, or they may be customized to fit certain models of vehicles. The headrest mounts might be made of a strong canvas or other cloth or woven material, comprised of materials such as vinyl or cotton or polyester, or could be made of solid “cup” type construction, such as using plastic. The headrest mounts basically provide a “cup” shape that is about the size of the headrest in volume to be snugly put over the headrest in a relatively tight and secure manner. These headrest mounts might be made permanently affixed to the respective sidewalls, or they might be provided as removable and adjustable as described in more detail hereinbelow.

The snugness of the headrest mounts may be provided by adapting the size of customized mounts designed for particular vehicles, or by making them adjustable, or using an elastic strap on the bottoms of the “cups” to slip over the headrest (like a “sock”) and tightly encircle the headrests. Hence, the headrest mounts may include adjustment mechanisms, such as Velcro straps, zippers, snaps, elastic bands, or snap flaps or other adjustments in order to allow configurability and to secure the headrest mounts in a tight and safe manner to avoid any disruption during events such as accidents or quick stops. For example, straps that go under the headrest from a front, to connect to a back using a connector such as Velcro or snaps, may be utilized. Installation may require that the headrests put into a deployed position, or it may not, but in any case may allow the adjust of the headrests after installation for driver and passenger safety and comfort.

The headrest mounts used for a front seat may include some type of soft padding or other cushioning to comfort the head of the front seat driver and/or passenger. The length of the device between the front and rear seats can be made adjustable using one or more zipper compartments to accommodate different seat positions relative to the height of the driver and or passenger.

As further shown in FIG. 1, the bed portion comprising sidewalls 11, 12, and the bottom 13 can be shaped as a “U” with a curved (or alternatively flat) bottom 13 that gives the animal a comfortable ride in the interior region 14, while protecting the interior of the automobile (e.g., the seats, seat backs, floors, etc.). This bed portion can also be comprised of a canvas material, comprised of cotton, vinyl, polyester, or some other strong material that will withstand abuse from the animal (e.g., in particular, the claws and teeth of dogs and cats). The bed will have back and front sidewalls 11, 12, such that the front sidewall protects the back of the front seats, and the back sidewall protects the front of the back seats, from damage during use. Note that these sidewalls 11, 12 can be used to constrain an animal from entering or being thrown through gaps in both the front and back seats (in particular where seats are designed as bucket seats or captains chairs for example). The bottom 13 and/or sidewalls 11, 12 may be provided with padding to keep the animal comfortable.

As shown in FIGS. 2 and 3, a zipper 25, 26 may be provided at a midpoint of the bed in either the front or back, or both, sidewalls to ease installation, and/or provide access to the animal, such as to provide ingress and egress or to feed or otherwise care for the animal. In addition, transparent windows might be provided within portions of the sidewalls to allow the animal to view the front or back portions of the vehicle. A front center zipper can be provided a Velcro flap that travels the complete length of the zipper for strength and keeps the animals safe during a front collision

Bottom corner structure(s) 15 provided on the bed at the point of connection between the bottom 13 and the respective sidewalls 11, 12 may be provided using reinforced material or structures to strengthen the device and help ensure that the bed is provided with a flatter bottom to avoid the bed collapsing on the animal. These bottom corner structures 15 might be constructed of a stiff material or solid portions, such as plastic, that might be provided on a surface of the bed, or as inserts, for example.

As further shown in FIGS. 1-4, fastening straps or hooks 41, 42 can be provided to attach the bed portion to child seat mounting hardware provided at the back seat(s) of the vehicle in order to secure the bed to the seat to also ensure that the bed maintains a comfortable bottom portion and remains in place and in the proper shape. These hooks may be used in conjunction with, or as an alternative to, the bottom corners. These car seat fasten point hooks 41, 42 prevent the bed from sliding side to side in an accident or when the animals ingress or egress. Rear portion hooks can allow fastening of the bed in place when the rear seat is down for hauling cargo.

As also shown in the figures, the bed may be provided with one or more utility pockets 31 having one or more openings 32 for receiving storing items, and it may also be provided with straps or loops to support the mounting of an item such as a firearm, such as a rifle. FIGS. 1-4 show an example utility pocket 31 installed on the front sidewall 12, but it could be installed on the back sidewall 11, or a utility pocket 31 could be installed on both sidewalls 11, 12.

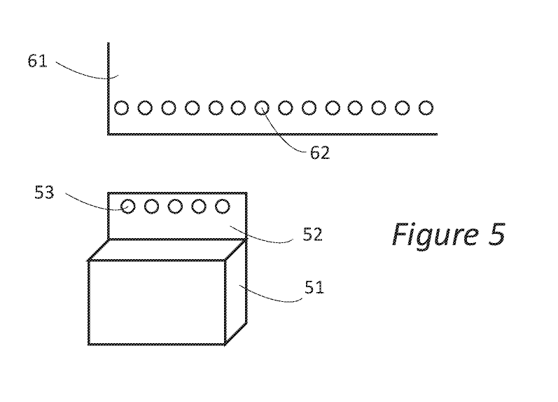

FIG. 5 shows an alternative embodiment of a removable and adjustable headrest mount 51 having a flap 52 with a plurality of snaps 53. Corresponding snaps 62 will be provided along a sidewall 61, allowing the mount 51 to be moved along the sidewall 61. Alternatively, the removable and adjustable headrest mount could be attached using another mechanism, such as Velcro, for example. This design, which can be used with any of the above embodiments for any or all of the headrests would allow a generic device to be used in multiple different types of vehicles.

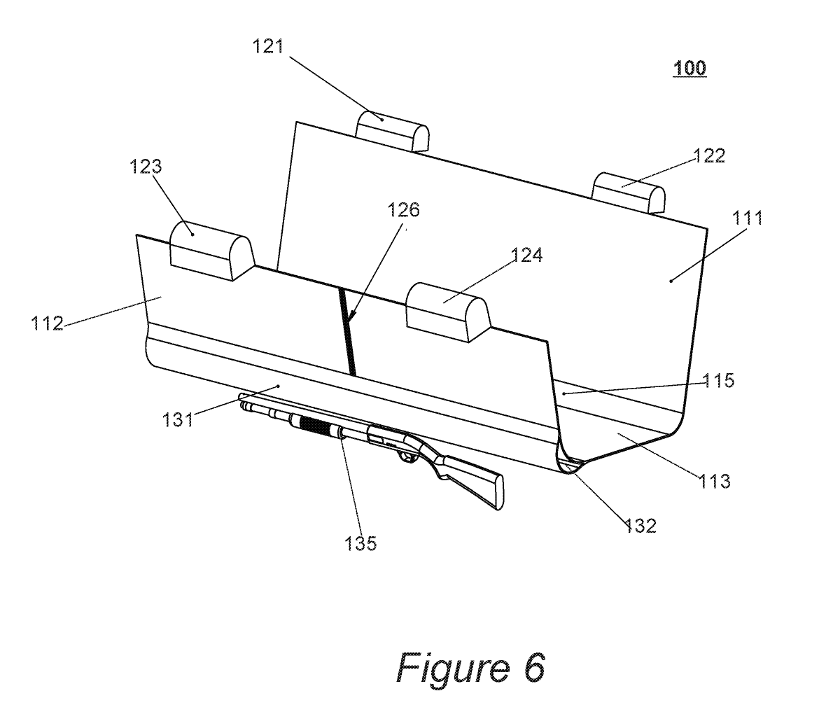

FIG. 6 shows an alternative, related embodiment 100 having sidewalls 111, 112, a bottom 113, a plurality of headrest mounts 121, 122, 123, and 124, a zipper 125, a reinforcing corner 115, utility pocket 131 with opening 132 for holding an item such as a rifle 135. Any of the components of this embodiment can utilized structures as defined for the related embodiment 10 as described above.

Note that in use the device will tend to conform to the seats of the row in which the device is installed in the vehicle. The device my be sized so that the bottom “extends” outward over the floor of the row of seats in which it is installed. Note that in three or more row vehicles, the front portion of the bed need not be installed on the front seats of the vehicle, but can be installed on any given seats of a row in front of the row in which the device is being installed. The device can be removed for ease of cleaning.

Alternative designs might support a device that is installed on only one side or the other of the rear seating, to keep a seat open for one or more passengers, such as by using only a single front and a single rear headrest mount, in such a design utilizing only a single front and back headrest, and may include an additional sidewall separating the passenger compartment from the bed to keep the animal on the bed.

In some alternatives additional sidewall(s) might be provided to protect one or both vehicle doors and better contain the animal within the device. Such sidewalls might be made removable or otherwise accessible using a zipper or Velcro, for example, provided around the edge of the additional sidewall(s).

One particular design of the device is made from 18 oz vinyl material that can be high pressure washed, such as at the car wash. It utilizes the front and rear headrest mounts for mounting and strength. It is much stronger than straps, and keeps the bed in place. The device also utilizes the car seat loops for connecting to factory child seat mounts. This allows the user to lift off the rear head rest pockets so passengers can ride safely in back with the animal(s). A user can also use the device to cover the floor in back if the rear seats are folded down. The front head rests hold it in place when used in this way. There is a center zipper provided on the front sidewall that is placed between the front vehicle seats so a user in the front seat can access the back seat and/or the animal, if needed. The device also has a hidden pocket the complete width of the bed to conceal a fishing rod or rifle or shot gun. There is an additional zipper to take up any the slack in the bed when the driver is shorter than average.

The sling bed device can be installed in the vehicle by a dealer, mechanic, or the vehicle owner. It can be sold as part of the original vehicle sale, or as an after-market accessory. The device is installed by placing the device in a rear row of the vehicle. The front or rear headrest mounts are installed first by placing the headrest mounts over the headrest and securing any straps. The straps or other connectors to connect the bed to the rear seat are installed, and then the other set of headrest mounts are installed. The order of these steps may be changed, but since one needs access to the seats to install the seat straps, it is best to do that first, or after only one set of headrest mounts have been installed for ease of access.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A device for installation in a vehicle comprising:
a bed having a first sidewall, a second sidewall, and a bottom provided between said first sidewall and said second sidewall;
a front headrest cup attached to an edge of the first sidewall of the bed; and
a back headrest cup attached to the edge of the second sidewall of the bed, wherein
said device is configured such that said front headrest cup is adapted to cup a first row headrest in the vehicle, and said back headrest cup is adapted to cup a second row headrest in the vehicle, and wherein
when said bed is installed in the vehicle, the first sidewall forms a wall along the first row, said second sidewall forms a wall along said second row, and said bottom forms a base between said first sidewall and said second sidewall for holding material in said device.

2. The device of claim 1, further comprising a utility pocket provided at a juncture between one of the sidewalls and the bottom.

3. The device of claim 1, further comprising another front headrest cup attached to an edge of the first sidewall of the bed, and another back headrest cup attached to the edge of the second sidewall of the bed.

4. The device of claim 1, further comprising a zipper provided along a width of one or both of the sidewalls.

5. The device of claim 1, further comprising a reinforcing structure provided along a junction of at least one of the sidewalls and the bottom.

6. The device of claim 1, wherein at least one of the headrest mounts is adjustably attached to the respective sidewall.

7. The device of claim 1, wherein at least one of the headrest mounts is removably attached to the respective sidewall.

8. The device of claim 1, wherein at least one of the headrest mounts can be adjustably secured to the respective headrest.

9. A method of installing a device in a vehicle, comprising the steps of:
providing the device of claim 1; and
connecting the headrest mounts to respective headrests in adjacent rows of the vehicle by slipping the headrest mounts over the respective headrests.

10. A device for installation in a vehicle comprising:
a bed having a first sidewall, a second sidewall, and a bottom provided between said first sidewall and said second sidewall;
a first headrest cup attached to an edge of the first sidewall of the bed toward a first end of the first sidewall;
a second headrest cup attached to the edge of the first sidewall of the bed toward a second end of the first sidewall;
a third headrest cup attached to an edge of the second sidewall of the bed toward a first end of the second sidewall; and
a fourth head rest cup attached to an edge of the second sidewall of the bed toward a second end of the second sidewall, wherein
said device is configured such that said first headrest cup is adapted to cup a first first row headrest in the vehicle, said second headrest cup is adapted to cup a second first row headrest in the vehicle, said third headrest cup is adapted to cup a first second row headrest in the vehicle, and the fourth headrest cup is adapted to cup a second second row headrest in the vehicle, and wherein
when said bed is installed in the vehicle, the first sidewall forms a wall along the first row, said second sidewall forms a wall along said second row, and said bottom forms a base between said first sidewall and said second sidewall for holding material in said device.

11. The device of claim 10, further comprising a utility pocket provided at a juncture between one of the sidewalls and the bottom.

12. The device of claim 10, further comprising a zipper provided along a width of one or both of the sidewalls.

13. The device of claim 10, further comprising a reinforcing structure provided along a junction of at least one of the sidewalls and the bottom.

14. The device of claim 10, wherein at least one of the headrest mounts is adjustably attached to the respective sidewall.

15. The device of claim 10, wherein at least one of the headrest mounts is removably attached to the respective sidewall.

16. The device of claim 10, wherein at least one of the headrest mounts can be adjustably secured to the respective headrest.

17. A method of installing a device in a vehicle, comprising the steps of:
providing the device of claim 10; and
connecting the headrest mounts to respective headrests in adjacent rows of the vehicle by slipping the headrest mounts over the respective headrests.

18. A device for installation in a vehicle comprising:
a bed having a first sidewall, a second sidewall, and a bottom provided between said first sidewall and said second sidewall;
a first headrest cup attached to an edge of the first sidewall of the bed toward a first end of the first sidewall;
a second headrest cup attached to the edge of the first sidewall of the bed toward a second end of the first sidewall;
a third headrest cup attached to an edge of the second sidewall of the bed toward a first end of the second sidewall;
a fourth head rest cup attached to an edge of the second sidewall of the bed toward a second end of the second sidewall;
a utility pocket provided at a juncture between one of the sidewalls and the bottom; and
at least one zipper provided along a width of at least one of the sidewalls configured to provide access to an interior of the bed, wherein
said device is configured such that said first headrest cup is adapted to cup a first first row headrest in the vehicle, said second headrest cup is adapted to cup a second first row headrest in the vehicle, said third headrest cup is adapted to cup a first second row headrest in the vehicle, and the fourth headrest cup is adapted to cup a second second row headrest in the vehicle, and wherein
when said bed is installed in the vehicle, the first sidewall forms a wall along the first row, said second sidewall forms a wall along said second row, and said bottom forms a base between said first sidewall and said second sidewall for holding material in said device.

19. The device of claim 18, further comprising a securable flap for covering the zipper.

20. A method of installing a device in a vehicle, comprising the steps of:
providing the device of claim 18;
connecting the headrest mounts to respective headrests in adjacent rows of the vehicle by slipping the headrest mounts over the respective headrests; and
holding a pet in said device.
